(19) United States
(12) Patent Application Publication
(10) Pub. No.: US 2014/0178284 A1
(43) Pub. Date: Jun. 26, 2014

(54) METHOD FOR PRODUCING HIGHER SILANES WITH IMPROVED YIELD

(71) Applicants: Jürgen Erwin Lang, Karlsruhe (DE); Hartwing Rauleder, Rheinfelden (DE); Ekkehard Mueh, Rheinfelden (DE)

(72) Inventors: Jürgen Erwin Lang, Karlsruhe (DE); Hartwing Rauleder, Rheinfelden (DE); Ekkehard Mueh, Rheinfelden (DE)

(73) Assignee: Evonik Degussa GmbH, Essen (DE)

(21) Appl. No.: 14/232,128

(22) PCT Filed: May 15, 2012
(86) PCT No.: PCT/EP2012/059027

§ 371 Date: Feb. 20, 2014

(30) Foreign Application Priority Data
Jul. 11, 2011 (DE) 10 2011 078 942.1

(51) Int. Cl. C01B 33/107; C01G 17/04

(52) U.S. Cl. CPC C01B 33/10773; C01G 17/04
USPC 423/342; 204/157.45; 204/157.48; 423/494

(57) ABSTRACT

The invention relates to a method for producing hexachlorodisilane or Ge2CI6, which is characterized in that, in a gas containing SiCI4 or GeCI4, a) a non-thermal plasma is generated by means of an alternating voltage of the frequency f, and wherein at least one electromagnetic pulse having the repetition rate g is coupled into the plasma, the voltage component of which pulse has an edge steepness in the rising edge of 10 V ns-1 to 1 kV ns-1 and a pulse width b of 500 ns to 100 μs, wherein a liquid phase is obtained, and b) pure hexachlorodisilane or Ge2Cl6 is obtained from the liquid phase.

The invention relates to a process for preparing dimeric and/or trimeric silicon compounds, especially silicon-halogen compounds. In addition, the process according to the invention is also suitable for preparation of corresponding germanium compounds. The invention further relates to an apparatus for performance of the process, and to the use of the silicon compounds prepared.

Silicon compounds and germanium compounds which are used in microelectronics, and also in photovoltaics, for example for preparation of high-purity silicon by means of epitaxy, or silicon nitride (SiN), silicon oxide (SiO), silicon oxynitride (SiON), silicon oxycarbide (SiOC), silicon carbide (SiC), mixed SiGe or germanium layers, must meet particularly high demands on the purity thereof. This is especially true in the case of production of thin layers of these materials. In this field of application, even impurities in the starting compounds in the ppb to ppt range are troublesome. For example, hexachlorodisilane in the production of silicon layers in microelectronics must meet the very highest purity demands, and at the same time be available particularly inexpensively in large amounts.

For production of the high-purity compounds mentioned, silicon nitride, silicon oxide, silicon oxynitride, silicon oxycarbide and silicon carbide, especially layers of these compounds, hexachlorodisilane is converted by reaction with further nitrogen-, oxygen- or carbon-containing precursors. Hexachlorodisilane is also used for production of epitaxial silicon layers by means of low-temperature epitaxy. Most layers product by means of CVD (Chemical Vapor Deposition) processes have layer thicknesses of a few nanometers, for example in the sector of transistor production in memory chips, or up to 100 μm in the sector of thin-film photovoltaics.

Known prior art processes use, for preparation of halogen compounds of silicon, for example for preparation of hexachlorodisilane (disilicon hexachloride), the reaction of chlorine or hydrogen chloride with calcium silicide or else with copper silicide. A further process consists in the reaction of tetrachlorosilane (silicon tetrachloride) when it is passed over molten silicon (Gmelin, System No. 15, part B, 1959, pages 658 to 659). A disadvantage of both processes is the concurrence of chlorination of the impurities present in the calcium silicide and in the silicon, which are then entrained into the product. If the hexachlorodisilane is to be used in the production of semiconductors, these impurities are unacceptable.

According to the disclosure of German patent DE 1 142 848 from 1958, we obtain ultrahigh-purity hexachlorodisilane when gaseous silicochloroform is heated to 200 to 1000° C. in an electrode burner and the gas mixture obtained is cooled and condensed rapidly. To increase the efficiency, the silicochloroform is diluted with hydrogen or an inert gas before the reaction.

German patent DE 1 014 971 from 1953 relates to a process for preparing hexachlorodisilane, in which silicon tetrachloride is reacted with a porous silicon moulding at elevated temperature, preferably at more than 1000° C., in a hot wall reactor.

DE-A 3 62 493 discloses a further process for preparing hexachlorodisilane. Here, hexachlorodisilane is prepared on the industrial scale by reacting silicon alloys or metallic silicon with chlorine using a vibration reactor at temperatures in the range from 100 to 500° C.

D. N. Andrejew (J. für praktische Chemie, Series 4. Vol. 23, 1964, pages 288 to 297) describes the reaction of silicon tetrachloride (SiCI₄) in the presence of hydrogen (H₂) under plasma conditions to give hexachlorodisilane (Si₂Cl₆) and higher chlorinated polysilanes. The reaction products are obtained as a mixture. A disadvantage of this process is that this product mixture is obtained in highly viscous to solid form and can therefore precipitate on the reactor wall. Likewise disclosed is the reaction of alkylsilanes such as methyltrichlorosilane (MTCS) in the presence of hydrogen in a plasma to give hexachlorodisilane and a multitude of undesired by-products. A feature common to both embodiments is the disadvantageous additional requirement for hydrogen as a reducing agent.

WO 2006/125425 A1 relates to a two-stage process for preparing bulk silicon from halosilanes. In the first step, preferably halosilanes, such as fluoro- or chlorosilanes, are exposed to a plasma discharge in the presence of hydrogen. In the second stage which follows, the polysilane mixture obtained from the first stage is pyrolysed to silicon at temperatures from 400° C., preferably from 700° C.

WO 2008/098640, the disclosure-content of which is explicitly incorporated into the present description, describes a two-stage process for obtaining, by a non-thermal plasma treatment of a silicon compound, at least one silane in high purity, which is removed by distillation. When the silicon compound is SiCl₄, in which case it is optionally possible to use hydrogen-containing silanes, the process affords hexachlorodisilane.

It was thus an object of the present invention to further develop this process in such a way that hexachlorodisilane is obtained in the required purity with improved yield.

It has been found that, surprisingly, injection of at least one periodic electromagnetic pulse into the nonthermal plasma which is generated in an SiCl₄-containing gas increases the yield of hexachlorodisilane. It has likewise been found that injection of at least one periodic electromagnetic pulse into the nonthermal plasma which is generated in a GeCl₄-containing gas increases the yield of Ge₂Cl₆.

The invention thus provides a process for preparing hexachlorodisilane or Ge₂Cl₆, which is characterized in that, in a gas comprising SiCl₄ or GeCl₄,
a) a nonthermal plasma is activated by means of an AC voltage of frequency f, and
at least one electromagnetic pulse with repetition rate g injected into the plasma
has a voltage component having an edge slope in the rising edge of 10 V ns⁻¹ to 1 kV ns⁻¹, and a pulsewidth b of 500 ns to 100 μs, to obtain a liquid phase, and
b) pure hexachlorodisilane or Ge₂Cl₆ is obtained from the liquid phase.

It is a considerable advantage of the process according to the invention that the addition of a reducing agent, such as hydrogen, can be dispensed with. In contrast to the known prior art processes, a mobile, homogeneous reaction mixture is obtained. In addition, no precipitates or oily substances form. More particularly, the reaction mixture does not solidify in the course of storage at room temperature. There is advantageously highly selective formation of hexachlorodisilane or Ge₂Cl₆, such that almost exclusively the dimeric chlorinated compound is already present in the liquid reaction product. The process according to the invention enables controlled provision of the products in pure and highly pure form, more particularly after distillative purification. The silicon compounds prepared by the process according to the invention are suitable for use in the semiconductor industry or pharmaceutical industry.

The invention therefore further provides for the use of the compound obtained by the process according to the invention as a precursor for the deposition of thin layers, preferably for the deposition of thin silicon, silicon oxide, silicon nitride, silicon carbide, SiOC, SiON, SiGe or germanium layers.

The process according to the invention has the further advantage that the addition of expensive, inert noble gases can be dispensed with. It is alternatively possible to add an entraining gas, preferably a pressurized inert gas, such as nitrogen, argon, another noble gas or mixtures thereof.

The gas in which the nonthermal plasma is generated may, as well as silicon tetrachloride, also contain hydrogen-, organyl- and/or halogen-containing silicon compounds. The organyl may comprise a linear, branched and/or cyclic alkyl having 1 to 18 carbon atoms, linear, branched, and/or cyclic alkenyl having 2 to 8 carbon atoms, unsubstituted or substituted aryl and/or corresponding benzyl; more particularly, the organyl may contain hydrogen, or halogen, in which case the halogen is selected from fluorine, chlorine, bromine and/or iodine.

According to the invention, hexachlorodisilane or Ge₂Cl₆, according to whether the gas contains SiCl₄ or GeCl₄, is surprisingly formed with high selectivity. By-products are formed only to a minor degree.

If required, unconverted reactants can be fed back to the nonthermal plasma. For complete conversion of the reactants in hexachlorodisilane or Ge₂Cl₆, it is possible to use a cycle mode with 1 to 100 cycles. Preference is given to running through a small number of 1 to 5 cycles, more preferably only one cycle. The silicon or germanium compound obtained by means of the reaction in nonthermal plasma is already present in pure form in the resulting phase, from which it can be obtained in high purity; more particularly, it can be subjected to a distillative workup, preferably in a multicolumn system. In this way, it is possible, for example, to isolate hexachlorodisilane in ultrahigh purity from the other reaction products and reactants. The metallic contamination of the silicon or germanium compound obtained in accordance with the invention with other metal compounds is at least in the ppm range down to the ppt range, preferably in the single-digit ppb range.

The nonthermal plasma is generated in a plasma reactor in which a plasmatic conversion of matter is induced and is based on anisothermal plasmas. Characteristics of these plasmas are a high electron temperature Tₑ≧10⁴ K and relatively low gas temperature T_{G}≦10³ K. The activation energy needed for the chemical processes is provided predominantly via electron impacts (plasmatic conversion of matter). Typical nonthermal plasmas can be generated, for example, by glow discharge, HF discharge, hollow cathode discharge or corona discharge. The working pressure at which the inventive plasma treatment is performed is between 1 and 10000 mbar_{abs}, preferably 1 to 1000 mbar_{abs}, more preferably 100 to 500 mbar_{abs}, especially 200 to 500 mbar_{abs}, the phase to be treated preferably being adjusted to a temperature of −40° C. to 200° C., more preferably to 20 to 80° C., most preferably to 30 to 70° C. In the case of germanium compounds, the corresponding temperature may be different—either higher or lower.

For a definition of nonthermal plasma and of homogeneous plasma catalysis, reference is made to the relevant technical literature, for example to “Plasmatechnik: Grundlagen and Anwendungen—Eine Einführung [Plasma technology: Fundamentals and applications—An introduction]; collective of authors, Carl Hanser Verlag, MunichNienna; 1984, ISBN 3-446-13627-4”.

Paschen's law states that the breakdown voltage for plasma discharge is essentially a function of the product p·d of the pressure of the gas p and the electrode separation d. For the process according to the invention, this product is in the range from 0.001 to 300 mm·bar, preferably from 0.01 to 100 mm·bar, more preferably 0.05 to 10 mm·bar, especially 0.07 to 2 mm·bar. The discharge can be activated by means of various types of AC voltages and/or pulsed voltages of 1 to 1000 kV. The magnitude of the voltage depends, in a manner known to those skilled in the art, not only on the p·d value of the discharge arrangement but also on the process gas itself. Of particular suitability are those pulsed voltages which enable high edge slopes and simultaneous formation of the discharge over the entire discharge space of the reactor.

The profile of the AC voltage and/or of the electromagnetic pulses injected against time may be square, trapezoidal, pulsed or composed of sections of individual profiles against time. AC voltage and electromagnetic pulses injected may be combined in any of these forms of the profile against time.

The frequency f of the AC voltage in the process according to the invention may be within a range from 1 Hz to 100 GHz, preferably from 1 Hz to 100 MHz. The repetition rate g of the electromagnetic pulses superimposed on this base frequency may be selected within a range from 0.1 kHz to 50 MHz, preferably from 50 kHz to 50 MHz. The amplitude of these pulses may be selected from 1 to 15 kVₚₚ (kV peak to peak), preferably from 1 to 10 kVₚₚ, more preferably from 1 to 8 kVₚₚ.

These pulses may have all shapes known to those skilled in the art, for example sine, square, triangle, or a combination thereof. Particularly preferred forms are square or triangle.

This already increases the time-based yield of hexachlorodisilane considerably compared to prior art processes without injected electromagnetic pulse and a sinusoidal profile of the AC voltage which generates the plasma.

A further increase in the yield can be achieved when, in the process according to the invention, at least one further electromagnetic pulse with the same repetition rate is superimposed on the electromagnetic pulse injected into the plasma, or both or at least two pulses are in a duty ratio of 1 to 1000 relative to one another. Preferably, both pulses are selected with a square shape, each with a duty ratio of 10 and maximum edge slope. The greater the edge slope, the higher the yield. The amplitude selected for these pulses may be 1 to 15 kVₚₚ, preferably 1 to 10 kVₚₚ.

The yield rises with the repetition rate. It has been observed, for example, that a saturation effect is found in the case of repetition rates with several times the base frequency, for example 10 times the base frequency, i.e. no further increase in yield occurs. The inventors are of the view, without being bound here to a particular theory, that this saturation effect depends on the gas composition, the p·d value of the experimental setup, and also on the electrical adjustment of the plasma reactor to the electronic ballast.

In the process according to the invention, the electromagnetic pulse(s) can be injected through a pulse ballast with current or voltage impression. If the pulse is current-impressed, a greater edge slope is obtained.

In a further version of the process according to the invention, the pulse may be injected, in a manner known to those skilled in the art, also in a transiently asynchronous rather than periodically synchronous manner.

In a further version of the process according to the invention, the reactor may be equipped with tubular dielectric material in order to prevent inhomogeneous fields in the reaction chamber and hence uncontrolled conversion. The ratio of reactor tube diameter to length thereof is preferably 300 mm/700 mm for 50 tubes. Additionally preferably, the reactor with the low-capacitance dielectric material and the low-resistance ballast of broadband design form one unit.

In the process according to the invention, it is possible to use, in the reactor, tubes which are held and spaced apart by spacers made from inert material. Such spacers are used to balance out manufacturing tolerances of the tubes and at the same time to minimize the mobility thereof in the reactor.

It may likewise be advantageous to use spacers made from a low-K material in the process according to the invention. More preferably, it is possible to use Teflon, which is known to those skilled in the art.

In the inventive embodiment of the process, it is possible to convert at least one further hydrogen-containing silicon compound together with SiCl₄ in a plasma reactor for gas phase treatment, more particularly without addition of a reducing agent. Examples of silicon compounds include trichlorosilane, dichlorosilane, monochlorosilane, monosilane, methyltrichlorosilane, dimethyldichlorosilane, trimethylchlorosilane and/or propyltrichlorosilane.

This also applies to the corresponding Ge compounds.

An alternative preferred embodiment envisages the reaction of silicon tetrachloride only with further hydrosilanes such as trichlorosilane. Further preferred embodiments envisage the reaction of silicon tetrachloride only with silanes containing organyl groups; for example, methyltrichlorosilane is added to the tetrachlorosilane and then the mixture is supplied to the reactor. The two alternative embodiments are effected, more particularly, without addition of a reducing agent.

Generally preferred process variants envisage a reaction of the silicon tetrachloride with hydrosilanes, for example trichlorosilane and/or alkyl-containing silicon compounds, such as methyltrichlorosilane, in a nonthermal plasma treatment, more particularly without addition of a reducing agent.

The silicon or germanium compound formed in process step a) can be enriched in a collecting vessel of the apparatus for performing the process, for example in the bottom of the apparatus, and can be sent to a distillative workup.

Process steps a) and/or b) can be performed batchwise or continuously. A particularly economically viable process regime is one in which process steps a) and b) proceed continuously.

The gas containing SiCl₄ or GeCl₄ can be supplied continuously to the plasma reactor for gas phase treatment, and the SiCl₄ or GeCl₄ may be enriched in the gas beforehand. The higher-boiling reaction products are separated out of the phase which forms in a collecting vessel.

Both in step a) and in step b) of the process according to the invention, the operation can be monitored continuously. As soon as the reaction product has reached a sufficient concentration in the collecting vessel (“bottoms”), the distillative workup for removal thereof can be effected in continuous or batchwise operating mode. For a batchwise distillative workup, one column is sufficient for separation. For this purpose, the compound is withdrawn in high or ultrahigh purity at the top of a column with a sufficient number of plates. The required purity can be checked by means of GC, IR, NMR, ICP-MS, or by resistivity measurement or GD-MS after deposition of the Si.

According to the invention, the continuous workup of the process products can be effected in a column system with at least two columns, preferably in a system with at least 3 columns. In this way, for example, the hydrogen chloride gas (HCl) likewise formed in the reaction can be removed overhead by means of what is called a low boiler column, first column, and the mixture collected from the bottoms can be separated into its constituents, by distillatively removing silicon tetrachloride (SiCl₄) at the top of a second column and hexachlorodisilane (Si₂Cl₆) at the top of a third column. In this way, the reaction mixture obtained from the plasma reactor can be separated by rectification, and the hexachlorodisilane or octachlorotrisilane reaction product can be obtained in the desired purity. The distillative workup of the silicon compound can be effected either under standard pressure or under reduced or elevated pressure, especially at a pressure between 1 and 1500 mbar_{abs}. The top temperature of the column for distillative workup of the silicon compound has a top temperature between 50 and 250° C. The same applies to the germanium compounds.

The process products, which do not have a high level of contamination in any case, can be isolated in very high to ultrahigh purity by the distillative workup. The corresponding temperatures for workup of the germanium compounds may differ therefrom.

According to the invention, a reactor can be used for generation of the nonthermal plasma, and a collecting vessel and a column system for distillative workup; the column system for the continuous process regime may comprise at least two columns, especially at least 3 columns. In an appropriate variant, the column system may comprise four columns. In the batchwise process regime, one column is sufficient. The columns are, for example, rectification columns.

By virtue of the inventive use of a column system in the continuous process regime, it is possible, for example, to draw off hydrogen chloride gas by means of a low boiler column, directly from the apparatus at the top of the first column, then unconverted tetrachlorosilane can be withdrawn at the top of the second column, and higher-boiling reaction products at the top of the third column. When several higher-boiling reaction products are isolated, a fourth column may be connected.

In addition, in such an apparatus, as well as the reactor, it is also possible to use one or more further reactors connected in series or parallel. According to the invention, at least one reactor in the apparatus may be an ozonizer. This has the great advantage of the alternative possibility of use of commercial ozonizers, which significantly lowers the capital costs. The reactors of the invention are appropriately equipped with glass tubes, in which case the tubes are preferably arranged in parallel or coaxially, and are spaced apart by means of spacers made from inert material. A suitable inert material is especially Teflon.

The silicon or germanium compounds prepared by the process according to the invention are suitable for use in the semiconductor industry or pharmaceutical industry, since they have impurities only in the ppb range, preferably in the ppt range or lower. The compounds can be prepared in high and ultrahigh purity because the compounds are formed surprisingly selectively by the process according to the invention, and thus only a low level of by-products in small amounts disrupts the workup of the process products.

Therefore, the silicon or germanium compounds prepared in accordance with the invention are suitable for preparation of silicon nitride, silicon oxynitride, silicon carbide, silicon oxycarbide or silicon oxide, or germanium nitride, germanium oxynitride, germanium carbide, germanium oxycarbide or germanium oxide, especially for production of layers of these compounds.

The examples which follow illustrate the process according to the invention in detail, without restricting the invention thereto.

### COMPARATIVE EXAMPLE 1

### Sinusoidal Profile of the Plasma-Generating AC Voltage—Without Injected Electromagnetic Pulses

Silicon tetrachloride (SiCl₄) enriched with trichlorosilane (SiCl₃, abbreviated to TCS), wherein silicon tetrachloride is present in excess, was vapourized continuously and conducted into a nonthermal plasma in a gas discharge zone of a quartz glass reactor. The gas phase was conducted through the reactor at about 250 ml/h. While the gas phase flowed through the reactor, a sinusoidal AC voltage with a frequency f, f=1.9 kHz, and an amplitude of 35 kVₚₚ was applied. The power input in the reactor was about 40 W. The operating pressure was adjusted to about 300 mbar_{abs}.

The breakdown voltage was approx. 10 kV, and a mean discharge gap of approx. 1000 μm was established.

After passing through the reactor, the reaction mixture was collected in liquid form in a collecting vessel. The distillation was effected batchwise in a distillation apparatus with a 50 cm column with Sulzer metal packing. At a bottom temperature of about 70° C. and a pressure of 750 mbar_{abs}, silicon tetrachloride was distilled off at a top temperature of about 50° C. Subsequently, the pressure was lowered to about 65 mbar_{abs}, and pure hexachlorodisilane was distilled off at a bottom temperature around 80° C. The top temperature was around 70° C. The content of metallic impurities corresponded to the detection limit in ICP-MS.

A yield of hexachlorodisilane of 17 g/h was obtained.

### Example 1

As Comparative Example 1, except that an electromagnetic pulse with a square-wave profile and an amplitude of 8 kVₚₚ was additionally injected.

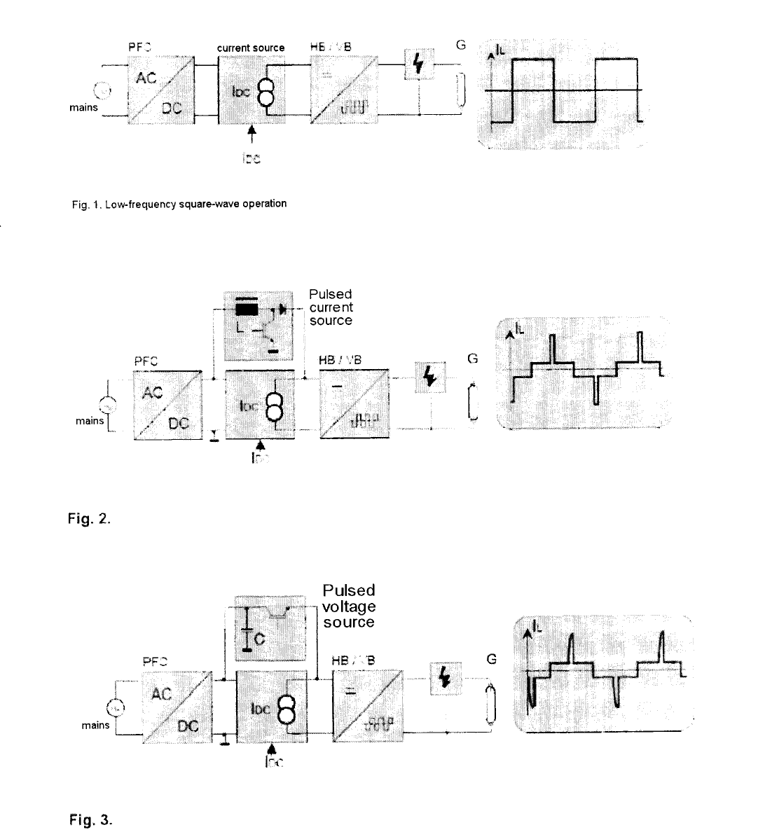

The edge slope in the rising part of the square-wave electromagnetic pulse was set to 10 kV/100 ns, the pulsewidth b =1 ps, and the repetition rate is g=400 Hz. The pulse I_{L} injected into the plasma in accordance with the invention had a low-frequency square-wave profile as a function of time. The arrangement with the quartz glass reactor G and the profile of the pulse are shown in FIG. 1.

A yield of 20 g/h of hexachlorodisilane was obtained.

### Example 2

As in Comparative Example 1, except that the square-wave pulse with the edge slope and amplitude as in Example 1 was injected with a further square-wave pulse with an amplitude of 10 kVₚₚ and with a duty ratio of 10.

The profile of the summated pulse I_{L} against time and the arrangement in the quartz glass reactor are shown in FIG. 2.

The yield was 24 g/h of hexachlorodisilane.

### Example 3

As Example 2, except that the pulses were injected by means of a pulse ballast with voltage impression. The further pulse had an amplitude of 12 kVₚₚ and a lower edge slope than that of Example 2. The profile thereof against time and the arrangement with the quartz glass reactor G are shown in FIG. 3.

A hexachlorodisilane yield of 22 g/h was obtained.

The results of the examples and of the comparative example are compiled in Table 1.

TABLE 1

| SiCl₄ | TCS | Impression | Yield (g/h) | Example |
|---|---|---|---|---|
| 99.9% | 0.1% | — | 17 | Comparative |
| 99.9% | 0.1% | Current | 20 | 1 |
| 99.9% | 0.1% | Current | 24 | 2 |
| 99.9% | 0.1% | Voltage | 22 | 3 |

1. Process A process for preparing hexachlorodisilane or Ge₂Cl₆,
the process comprising:
in a gas comprising SiCl₄ or GeCl₄,
a) activating a nonthermal plasma is generated in a reactor via an AC voltage of frequency f, and injecting into the plasma at least one electromagnetic pulse with
repetition rate g,
a voltage component having an edge slope in a rising edge of from 10 V ns⁻¹ to 1 kV ns⁻¹, and
a pulsewidth b of from 500 ns to 100 μs,
thereby obtaining a liquid phase, and
b) obtaining pure hexachlorodisilane or Ge₂Cl₆ is obtained from the liquid phase.

2. Process The process according to claim 1, wherein
the frequency f of the AC voltage is from 1 Hz to 100 MHz,
the repetition rate g is from 50 kHz to 50 MHz, and
an amplitude of the at least one electromagnetic pulse is from 1 to 15 kVₚₚ.

3. Process The process according to claim 1,
wherein
at least one further electromagnetic pulse with the same repetition rate is superimposed on the at least one electromagnetic pulse injected into the plasma, and both or at least two pulses are in a duty ratio of 1 to 1000 relative to one another.

4. Process The process according to any of the preceding claims claim 1,
wherein
the at least one electromagnetic pulse is injected through a pulse ballast with current or voltage impression.

5. The process according to any of the claim 1,
wherein
the reactor is an ozonizer.

6. Process The process according to any of the claim 1,
wherein
the liquid phase is distilled in said obtaining b).

7. The process according claim 1,
wherein
the liquid phase is distilled under a standard pressure, a reduced pressure or an elevated pressure.

8. The process according to claim 1,
wherein
the liquid phase is distilled at a pressure of from 50 to 1500 mbar.

9. The process according to claim 1,
wherein
said activating a) and said obtaining b) are carried out continuously, and the liquid phase obtained in said obtaining b) is subjected to a distillation.

10. The process according to claim 1,
wherein
the reactor is equipped with tubular dielectric material.

11. The process according to claim 1,
wherein
the reactor comprises tubes held and spaced apart by spacers made from inert material.

12. The process according to claim 11,
wherein
the reactor comprises a spacer made from a low-κ material.

13. A precursor for deposition of a thin layer, the precursor comprising hexachlorodisilane or Ge₂Cl₆ obtained by the process according to claim 1.

14. [[Use]] The precursor according to claim 13, wherein the thin layer is a thin silicon, silicon oxide, silicon nitride, silicon carbide, SiOC, SiON, SiGe or germanium layer.

15. The process according to claim 1, wherein the process prepares hexachlorodisilane.

16. The process according to claim 1, wherein the process prepares Ge₂Cl₆.
